(19) United States
(12) Patent Application Publication
(10) Pub. No.: US 2017/0271716 A1
(43) Pub. Date: Sep. 21, 2017

(54) MINIATURIZED ELECTRONIC COMPONENT WITH REDUCED RISK OF BREAKAGE AND METHOD FOR PRODUCING SAME

(71) Applicant: SCHOTT AG, Mainz (DE)

(72) Inventors: Ulrich PEUCHERT, Bodenheim (DE); Matthias JOTZ, Alfeld (Leine) (DE); Rüdiger SPRENGARD, Mainz (DE)

(73) Assignee: SCHOTT AG, Mainz (DE)

(21) Appl. No.: 15/611,387

(22) Filed: Jun. 1, 2017

Related U.S. Application Data
(63) Continuation of application No. PCT/EP2015/077923, filed on Nov. 27, 2015.

(30) Foreign Application Priority Data
Dec. 1, 2014 (DE) 102014117633.2
Mar. 16, 2015 (DE) 102015103857.9

(51) Int. Cl. H01M 10/0585; H01M 10/052; C03C 3/089; C03C 3/091; C03C 3/093; C03C 3/11; C03C 3/083; C03C 3/085; C03C 3/087; C03C 3/095; C03C 3/097; C03C 4/18; C03C 21/00; C03C 23/00; C03C 17/34; H01M 10/04

(52) U.S. Cl. CPC H01M 10/0585; H01M 10/0436; H01M 10/052; C03C 3/089; C03C 3/091; C03C 3/093; C03C 3/11; C03C 3/083; C03C 3/085; C03C 3/087; C03C 3/095; C03C 3/097; C03C 4/18; C03C 21/002; C03C 23/007; C03C 17/34; H01M 2010/0495; C03C 2204/00; C03C 2218/32

(57) ABSTRACT

A method for producing miniaturized electronic components is provided, where the miniaturized electronic components are obtained as singularized parts of a sheet-like glass which has structures applied thereon, in particular at least one layer. The method includes the steps of: providing a sheet-like glass toughened at least during a time period, as a substrate material; applying structures onto the substrate, in particular in the form of a sequence of coating processes and by processes for patterning of layers, so that at least portions of the substrate carry structures while other portions of the substrate remain free; subjecting the substrate carrying the structures to a thermal load; and singularizing so that the portions of the substrate carrying structures are obtained in singularized form. A miniaturized electronic component produced in this manner is also provided.

### CROSS REFERENCE TO RELATED APPLICATIONS

This application is a continuation of International Application No PCT/EP2015/077923 filed on Nov. 27, 2015, which claims the benefit under 35 U.S.C. 119 of German Application No. 102014117633.2 filed on Dec. 1, 2014 and German Application No. 102015103857.9 filed on Mar. 16, 2015, the entire contents of all of which are incorporated by reference herein.

### BACKGROUND

1. Field of the Invention

The invention generally relates to the production of electronic components, in particular those on which structures are provided on a substrate, for example in the form of a sequence of layers which may in particular be applied in patterned form, and also relates to substrates for producing such components. In particular, the invention relates to the use of special substrate materials for producing electronic components with a reduced risk of breakage.

2. Description of Related Art

Generally, there is a high demand for miniaturized electronic components, in particular those on which structures are applied on a substrate, for example in the form of a sequence of layers which may in particular be applied in patterned form. For example, such miniaturized electronic components might be microelectromechanical systems (short MEMS), but also thin film batteries, for example lithium-based thin film batteries.

For such miniaturized electronic components, the selection of suitable substrate materials is a key requirement. The substrates should have very small thicknesses of 300 μm or less and at the same time should be provided in large sizes of 6 inches or more in order to enable cost-efficient processes. Miniaturized in the sense of the invention is not limited to structures with nanometer dimensions, although these are included. Miniaturized means that techniques from the semiconductor industry can be used, for example typical substrate or wafer sizes which may even be 12 inches and more, for example, and that the structures according to the invention can be produced by means of these substrates and with dimensions that are often or even usually smaller than the dimensions of the substrates themselves. In this case, firstly layers are deposited on a large substrate, or wafer, in such a way that in individual areas of the substrate structures in form of deposited patterned layers are created. Subsequently a process for singularization of the substrate follows, so that the portions of the substrate that bear structures are obtained separately. Also, cost-efficient manufacturing of the substrate material itself is of great importance. Furthermore, the substrate material should preferably be flexible, should have a high chemical resistance and inertness with respect to the processes and substances used in the manufacturing process for electronic components, and should furthermore have a low density. For the above reasons, ceramics and semiconductor materials like for example silicon are often not suitable anymore for mass application.

In terms of flexibility of the substrate material and its mechanical durability, often polymers seem to be appropriate. However, polymers reach their limits where the manufacturing process of the electronic component includes a thermal treatment step, for example for post-treatment of a coating to create a particularly preferred form of a material. If the temperatures of such a thermal post-treatment exceed 150° C., conventional polymers cannot be used anymore. Instead, more expensive special materials, for example polyimides, must be used. If the processing furthermore requires transparency and/or scratch resistance of the substrate material, polymers are principally ruled out as a substrate.

Regarding the above-mentioned properties, substrates made of glass, in particular of thin glass with a thickness of 300 μm or less, appear to be the best choice for the substrate material. By variation of the chemical composition of the glass, the required optical, mechanical, electrical, and thermal properties thereof can be selectively adjusted; furthermore, mass production of such glasses in small thicknesses of 300 μm or less is industrially mastered.

However, these thin glasses are generally prone to glass breakage despite their theoretically very high strength, so that special measures are necessary regarding their handling and/or special methods to improve the mechanical resistance of thin glass.

For example, the mechanical stability of a thin glass can be improved by treating the cut edges of the glass in such a way that crack propagation starting from the cut edges is prevented, resulting in a reduced fracture probability. It is possible, for example, to coat the cut edges or to provide the edges with a suitable shape, for example in the form of rounded edges. However, such measures are only sufficient if especially thin substrates are required and flexibility, meaning also a possible bending of a substrate, only plays a subordinate role.

A further possibility is the usage of carriers, i.e. supports, onto which a thin glass is placed during the manufacturing process, the carrier thereby increasing the mechanical stability of the substrate during manufacturing. Following the processing, the thin glass substrate has to be detached from the carrier, which requires further processing steps, so that carrier-based methods are costly and therefore usually limited to high-priced and/or high-volume special applications.

The use of toughened, i.e. thermally and/or chemically toughened thin glass as substrate material, is likewise conceivable. Such glass can be better handled so that the risk of breakage before and during the coating processes for fabricating the electronic components is reduced. However, such a toughened glass cannot be cut or only with very high waste of material due to breakage.

Thus, there is a demand for flexible, thin substrate materials improved in terms of fracture resistance and with high chemical, mechanical and thermal stability for the fabrication of electronic components, which at the same time allow for simple singularization of a multitude of electronic components deposited on a large substrate area.

### SUMMARY

The object of the invention is to provide a method for producing a miniaturized electronic component. A further aspect of the invention relates to a miniaturized electronic component which is applied on a substrate material with reduced risk of breakage, and to the use of a toughened glass as a substrate material for manufacturing miniaturized electronic components.

The object of the invention is achieved in a simple way by a method for producing a miniaturized electronic component, a miniaturized electronic component, and by using a glass that is toughened at least during a period of time.

The method for producing miniaturized electronic components comprises at least the steps of: providing a sheet-like glass toughened at least during a time period, as a substrate material; applying structures onto the substrate, such structures being applied in particular in the form of a sequence of layers and by processes for patterning the layers, so that at least portions of the substrate carry structures while other portions of the substrate remain free; subjecting the substrate carrying the structures to a thermal load; and singularizing so that the portions of the substrate carrying the structures are obtained in singularized form.

A period of time herein refers to an interval of time which is longer than zero seconds and is at least in the range of a method or process step, which may have a typical duration from a few seconds up to several hours or days, so that the described advantages of the invention can be obtained.

In the present context, structures on the substrate refer to areas in which at least a single layer, but preferably multiple layers, are applied successively and partially overlapping one another, so that the portions of the substrate carrying structures differ in height from the surrounding substrate.

The structures can be applied by coating processes, in particular by physical and/or chemical deposition processes. Furthermore, wet chemical coating processes can also be used, for example printing, spraying, doctor blading, spin coating, or dip coating. The individual layers forming the respective structures are applied in horizontal succession, in which the individual layers overlap at least in portions thereof. In order to selectively prevent portions from being coated, any conventional masking processes or other processes for applying patterned layers can be used. It is in particular possible to use photolithographic processes in combination with etching processes for producing patterned layers, for example in lift-off or strip methods.

It may be of advantage if strength properties, especially the compressive stress at the surface of the glass, are alterable, in particular alterable so as to be adapted to the respective process step.

Toughened glass is better to handle, often even better coatable, and thus can contribute to simplified handling conditions and therefore to a higher yield.

If the yield is hereby improved in the first process steps and subsequently in favor of better cutting and singularization properties the glass is employed with a reduced compressive stress at the surface, this can lead to an altogether further improved processability and may thus provide substantial economic advantages.

In one embodiment of the invention, the sheet-like toughened glass has a thickness t of 300 μm or less, preferably of 150 μm or less, more preferably of 100 μm or less, and most preferably 50 μm or less. Thus, the glass which is used for producing miniaturized electronic components according to the invention is a as so-called ultra-thin glass.

In the present invention, a glass is referred to as being sheet-like if its lateral dimension in one spatial direction is at least half an order of magnitude smaller than in the other two spatial directions.

Preferably, the sheet-like toughened glass of the present invention is provided as chemically toughened glass. In this case, the chemical toughening is achieved by an ion exchange in an exchange bath and at the beginning of the process according to the invention it is distinguished by a thickness of the ion exchange layer (L_{DoL}) of at least 10 μm, preferably at least 15 μm, and most preferably at least 25 μm, and by a compressive stress (σ_{CS}) at the glass surface of preferably at most 480 MPa, more preferably at most 300 MPa, yet more preferably at most 200 MPa, or even less than 100 MPa.

According to one embodiment of the invention, the singularization is effected by cutting, in particular mechanical cutting, thermal cutting, mechanical scoring, laser cutting, laser scoring, or water jet cutting, or by hole drilling using an ultrasonic drill, and/or combinations thereof.

The thermal load is appropriately applied preferably during a thermal post-treatment of at least one of the functional layers of the miniaturized electronic component and/or during a process step for applying and/or patterning structures on the substrate, and/or as a combination of thermal post-treatment and a thermal load during another process step. Through the thermal loading, the prestress and thus the compressive stress at the surface of the glass can be selectively altered, in particular reduced, for example also by and at the same time with processes, which include thermal treatments of functional layers applied to the substrate. Hereby, advantageously, it is possible to improve the cutting properties of the glass and the achievable tolerances during cutting.

Due to an initially higher strength, in particular an increased strength achieved through toughening, the handling of glass-based substrates is easier and safer, whereas in subsequent processing steps, for example for more complex arrangements with layers deposited on the substrate, other advantageous requirements may arise, for example improved and more precise cutting properties.

In this manner, the yield or output of an industrial production process in sum can be significantly improved.

For example, the miniaturized electronic component may be a lithium-based thin film battery. Such a lithium-based thin film battery generally comprises a cathode collector which is applied to the substrate, provided that the substrate has no sufficient electric conductivity, a layer defining a cathode, an ion-conductive layer, and an anode collector, and the anode itself is usually only created during the first charging of the thin film battery and is being formed between the electrolyte layer and the anode collector. Suitable materials for such a cathode layer for a lithium-based thin film battery usually include transition metal oxides, for example LiCoO₂. In order to increase the efficiency of the battery, it is usually necessary for the cathode materials to perform a thermal post-treatment, which is usually accomplished in a range from 350 to 600° C., preferably in a range from 400 to 550° C., and often at 500° C. In this case, the thermal loading of the sheet-like chemically toughened glass may be accomplished during the thermal post-treatment of the cathode layer.

Thermal loads corresponding to a cumulative heat treatment between not less than 350° C. and not more than 600° C. during 1 to 15 hours have been found to be preferable.

For example, in one of the glasses described in more detail below, an initial compressive stress of about 930 MPa was reduced to about 450 MPa by thermal loading or annealing at 400° C. for eight hours. Furthermore, this initial compressive stress of about 930 MPa was decreased or reduced to about 120 MPa by thermal loading or annealing at 500° C. for eight hours.

In one of the further glasses described in more detail below, an initial compressive stress of about 370 MPa was reduced to about 190 MPa by thermal loading or annealing at 400° C. for eight hours. Furthermore, this initial compressive stress of about 370 MPa was reduced to a state without residual stress by thermal loading or annealing at 500° C. for eight hours.

By selecting appropriate ranges of temperature and time, residual compressive stresses at the surface of the glass can be adjusted in defined manner or can even be completely removed, in particular if the latter offers advantages for the manufacturing technology.

Surprisingly, it has been found that the processability of such a toughened, in particular chemically toughened sheet-like glass which is used as substrate material, can be improved generally and often also process-specifically by such a thermal load.

For example, on toughened glass it is usually not possible or very difficult to employ conventional methods for cutting or singularization of glass. Namely, because of the stress in the glass, a mechanical injury of the glass such as being caused, for example, during conventional glass cutting processes like mechanical scoring and breaking, mostly results in a complete mechanical destruction of the glass. If, however, specific methods are used to enable toughened glass to be separated nevertheless, the edges thus obtained do not have a quality within the usually required tolerances, but are characterized by chipping and non-exact cutting edge shapes, which would make the further processing of miniaturized electronic components more difficult. Thus, although the toughening of the glass generally improves the handling of the glass, in particular that of especially thin glass, so that breakage is reduced during normal processing, the singularization of the glass by cutting, however, is more difficult or even not possible, and is associated with increased material loss in any case, so that cost-effective fabrication of many electronic components on a wafer with the highest possible material utilization appeared not possible so far when using toughened sheet-like glass as a substrate.

By contrast, the method according to the invention allows to use a toughened sheet-like glass in the normal fabrication processes for miniaturized electronic components, so that the advantages of a toughened glass, in particular the reduced risk of breakage will take effect, in combination with sufficiently good cutting properties, so that the singularization of the individual miniaturized components is possible without high material loss.

So, surprisingly, it has been found that chemically toughened glasses are singularized much better after a temperature-time load or, more generally, after a thermal load.

It is known, in fact, that for example in case of thermally toughened glasses the compressive stress can be eliminated by thermal loading. Surprisingly, however, it has been found that this effect applies to chemically toughened glasses only to a limited extent. Thus, with chemically toughened glasses a thermal treatment leads to an equalizing diffusion of the ions across the cross section of the glass. However, it is possible in this case to control the thermal load in such a way that the initial prestress is not completely eliminated, so that even after thermal loading the provided glass still exhibits a reduced risk of breakage compared to a non-toughened glass.

Therefore, the method according to the invention makes it possible to easily exploit the advantages of a toughened glass in conventional processing steps in the production of miniaturized electronic components while at the same time achieving a high area yield of the substrate material. Even after completion of the method according to the invention, the employed glass substrate will have a higher breaking resistance than a non-toughened glass and thus increases the mechanical strength of the miniaturized electronic components obtained in this way.

Preferably the employed glass is a borosilicate glass and/or an aluminosilicate glass.

The thermal loading according to the invention is accomplished by conventional technical heating procedures. For example, the subjecting to a thermal load is effected by resistance heating and/or by electromagnetic radiation and/or by induction and/or combinations thereof.

The thermal loading during the method of the invention for fabricating miniaturized electronic components alters the initial stress condition of the chemically toughened glass without bringing the glass back to the initial stress-free condition. Even complete relaxation of the glass might be of advantage for the overall process and provides highly interesting and advantageous embodiments as well, in particular as described above.

The initial compressive stress of 100% at the surface of the glass will be reduced to preferably at least 50% of the compressive stress after the annealing, but may advantageously and process-specifically as well be relaxed to 20%, 10%, and even to 0% of compressive stress at the surface. However, at least during a period of time the increased compressive stress at the surface of the glass was advantageous for handling or for process steps of the method.

In individual cases, complete relaxation of the compressive stress at the surface of the glass to 0% is useful as well, especially if reliability, flexibility of the substrate, or improved cutting properties and best possible adherence to tolerance specifications of the cut miniaturized component, for example regarding its cut edges, are of interest.

The miniaturized electronic component as obtained upon completion of the method according to the invention is therefore distinguished by the fact that the glass used as a substrate for the structures is providing as an at least partially chemically toughened glass, wherein the at least partial chemical toughening is achieved by an ion exchange in an exchange bath and a subsequent thermal treatment, and is distinguished by a thickness of the ion exchange layer (L_{DoL}) of at least 10 μm, preferably at least 15 μm, and most preferably at least 25 μm, and by a compressive stress (σ_{CS}) at the glass surface of at most 480 MPa, preferably at most 300 MPa, more preferably at most 200 MPa, or even less than 100 MPa, wherein the thickness of the ion exchange layer prior to the thermal loading is smaller than the thickness of the ion exchange layer after the thermal loading, and wherein the compressive stress at the surface of the glass prior to the thermal loading is greater than the compressive stress at the surface of the glass after the thermal loading.

The compressive stresses given above may advantageously be higher during an initial processing phase, as mentioned, and may be lower during subsequent processing phases or even reach the value zero, in particular to advantageously meet the respective requirements of different method or process phases.

In a further advantageous embodiment of the invention, the compressive stress is completely eliminated during a final phase of the method, to allow for a simplified and more precise singularization. For these embodiments it is sufficient if at least during a period of time the substrate material is provided in the form of toughened glass, advantageously in particular during a period of time at the beginning of the method.

The glass used as the substrate for the structures of the miniaturized electronic component has a thickness t of 300 μm or less, preferably of 150 μm or less, more preferably of 100 μm or less, and most preferably of 50 μm or less.

Preferably, the employed glass is a borosilicate glass and/or an aluminosilicate glass.

In one embodiment of the invention, the miniaturized electronic component is designed as a thin film battery, preferably as a lithium-based thin film battery.

Thus, the invention in particular also includes the use of a chemically toughened glass as a substrate for fabricating miniaturized electronic components.

The chemical toughening is achieved by an ion exchange in an exchange bath. Prior to performing the method according to the invention, the glass is distinguished by a thickness of the ion exchange layer (L_{DoL}) of at least 10 μm, preferably at least 15 μm, and most preferably at least 25 μm, and by a compressive stress (σ_{CS}) at the glass surface of preferably at most 480 MPa, more preferably at most 300 MPa, yet more preferably at most 200 MPa, or even less than 100 MPa.

While performing the method of the invention, the stress condition of the glass used as the substrate is being altered due to process related reasons, so that a sufficient reduction of the stress condition for singularization is achieved. Surprisingly, it has been found that the prestress of the glass is hereby not reduced to zero, but that rather a residual stress is preserved in the glass, so that altogether the strength of the glass used as a substrate for miniaturized electronic components is increased compared to a conventional non-toughened glass. Therefore, the overall mechanical stability of the miniaturized electronic component manufactured according to the invention is improved as well as the general handling thereof.

The glass in the state as provided as the substrate in the finished miniaturized electronic component is distinguished by being an at least partially chemically toughened glass, wherein the at least partial chemical toughening is achieved by ion exchange in an exchange bath and a subsequent thermal treatment, and is distinguished by a thickness of the ion exchange layer (L_{DoL}) of at least 10 μm, preferably at least 15 μm, and most preferably at least 25 μm, and by a compressive stress (σ_{CS}) at the glass surface of at most 480 MPa, preferably at most 300 MPa, more preferably at most 200 MPa, or even less than 100 MPa, wherein the thickness of the ion exchange layer prior to the thermal loading is smaller than the thickness of the ion exchange layer after the thermal loading, and wherein the compressive stress at the surface of the glass prior to the thermal loading is greater than the compressive stress at the surface of the glass after the thermal loading.

In one embodiment of the invention, the chemical toughening of the glass is achieved in an exchange bath containing lithium ions, such as, for example, an exchange bath with different alkali ions, e.g. potassium and low to lowest contents of lithium. Also, a cascaded process may be performed, for example an exchange with potassium and a further quick exchange using a lithium-containing bath.

The use of a glass which has been chemically toughened in a lithium ion containing exchange bath is in particular of advantage if the miniaturized electronic component which is built on the glass is a lithium-based thin film battery. With a lithium-containing glass which contains lithium in the volume, at the surface and/or in a near-surface zone, the diffusion of lithium or lithium ions, especially from an electrode, can be avoided or at least greatly reduced and thus an improved corrosion resistance for the electrode is provided.

Preferably, a borosilicate glass and/or an aluminosilicate glass is used as the starting glass for chemical toughening.

Methods for chemical toughening or tempering of ultra-thin glasses are known from the prior art, for example from Applicant's own international patent application PCT/CN2013/072695. A person skilled in the art will know that different values of chemical prestress can be obtained in this way by appropriately varying the exchange parameters.

In a further embodiment of the invention, the sheet-like chemically toughened glass is applied onto a support or carrier and locally fixed before further process steps for producing the structures forming the electronic components follow. The separation of the glass substrate from the carrier after completion of all the deposition, coating and patterning steps which are necessary for creating the structures may be accomplished both before and after the thermal loading according to the invention.

Generally, however, due to the greater mechanical stability of the sheet-like chemically toughened glass used according to the invention, the elaborate methods of fixing the substrate to a support can be dispensed with, if the sole purpose of the support is merely to provide the substrate with an overall improved mechanical stability to minimize the risk of breakage.

### Exemplary Embodiment 1

The composition of a possible sheet-like chemically toughened glass for use as a substrate in a manufacturing process for miniaturized electronic components is given, by way of example, by the following composition, in wt %:

| | |
|---|---|
| SiO₂ | 30 to 85 |
| B₂O₃ | 3 to 20 |
| Al₂O₃ | 0 to 15 |
| Na₂O | 3 to 15 |
| K₂O | 3 to 15 |
| ZnO | 0 to 12 |
| TiO₂ | 0.5 to 10 |
| CaO | 0 to 0.1. |

Furthermore, the glass may contain minor constituents and/or traces, for example in the form of necessary processing-related additives such as, for example, refining agents, and further constituents such as impurities resulting from traces inevitably contained in the raw materials. These further constituents usually amount to a total of less than 2 wt %.

### Exemplary Embodiment 2

A particularly preferred exemplary glass has the following composition, in wt %, prior to the chemical toughening:

| | |
|---|---|
| SiO₂ | 64 |
| B₂O₃ | 8.3 |
| Al₂O₃ | 4.0 |
| Na₂O | 6.5 |
| K₂O | 7.0 |
| ZnO | 5.5 |
| TiO₂ | 4.0 |
| Sb₂O₃ | 0.6 |
| Cl⁻ | 0.1. |

With this composition, the following properties of the substrate are obtained:

| | |
|---|---|
| α₍₂₀₋₃₀₀₎ | 7.2 · 10⁻⁶/K |
| T_{g} | 557° C. |
| Density | 2.5 g/cm³. |

### Exemplary Embodiment 3

The composition of a further possible sheet-like chemically toughened glass for use as a substrate in a manufacturing process for miniaturized electronic components is given, by way of example, by the following composition, in wt %:

| | |
|---|---|
| SiO₂ | 50 to 65 |
| Al₂O₃ | 15 to 20 |
| B₂O₃ | 0 to 6 |
| Li₂O | 0 to 6 |
| Na₂O | 8 to 15 |
| K₂O | 0 to 5 |
| MgO | 0 to 5 |
| CaO | 0 to 7, |
| | preferably 0 to 1 |
| ZnO | 0 to 4, |
| | preferably 0 to 1 |
| ZrO₂ | 0 to 4 |
| TiO₂ | 0 to 1, preferably |
| | substantially |
| | free of TiO₂ |

Furthermore, the glass may contain minor constituents and/or traces, for example in the form of necessary processing-related additives such as, for example, refining agents, and further constituents such as impurities resulting from traces inevitably contained in the raw materials. These further constituents usually amount to a total of less than 2 wt %.

### Exemplary Embodiment 4

A particularly preferred exemplary glass has the following composition, in wt %, prior to the chemical toughening:

| | |
|---|---|
| SiO₂ | 62.3 |
| Al₂O₃ | 16.7 |
| Na₂O | 11.8 |
| K₂O | 3.8 |
| MgO | 3.7 |
| ZrO₂ | 0.1 |
| CeO₂ | 0.1 |
| TiO₂ | 0.8 |
| As₂O₃ | 0.7. |

With this composition, the following properties of the substrate are obtained:

| | |
|---|---|
| α₍₂₀₋₃₀₀₎ | 8.6 · 10⁻⁶/K |
| T_{g} | 607° C. |
| Density | 2.4 g/cm³. |

### Exemplary Embodiment 5

Another particularly preferred exemplary glass has the following composition, in wt %, prior to the chemical toughening:

| | |
|---|---|
| SiO₂ | 62.2 |
| Al₂O₃ | 18.1 |
| B₂O₃ | 0.2 |
| P₂O₅ | 0.1 |
| Li₂O | 5.2 |
| Na₂O | 9.7 |
| K₂O | 0.1 |
| CaO | 0.6 |
| SrO | 0.1 |
| ZnO | 0.1 |
| ZrO₂ | 3.6. |

With this composition, the following properties of the substrate are obtained:

| | |
|---|---|
| α₍₂₀₋₃₀₀₎ | 8.5 · 10⁻⁶/K |
| T_{g} | 505° C. |
| Density | 2.5 g/cm³. |

### Exemplary Embodiment 6

Furthermore, another particularly preferred exemplary glass has the following composition, in wt %, prior to the chemical toughening:

| | |
|---|---|
| SiO₂ | 52 |
| Al₂O₃ | 17 |
| Na₂O | 12 |
| K₂O | 4 |
| MgO | 4 |
| CaO | 6 |
| ZnO | 3.5 |
| ZrO₂ | 1.5. |

With this composition, the following properties of the substrate are obtained:

| | |
|---|---|
| α₍₂₀₋₃₀₀₎ | 9.7 · 10⁻⁶/K |
| T_{g} | 556° C. |
| Density | 2.6 g/cm³. |

### Exemplary Embodiment 7

A further particularly preferred exemplary glass has the following composition, in wt %, prior to the chemical toughening:

| | |
|---|---|
| SiO₂ | 62 |
| Al₂O₃ | 17 |
| Na₂O | 13 |
| K₂O | 3.5 |
| MgO | 3.5 |
| CaO | 0.3 |
| SnO₂ | 0.1 |
| TiO₂ | 0.6. |

With this composition, the following properties of the substrate are obtained:

| | |
|---|---|
| α₍₂₀₋₃₀₀₎ | 8.3 · 10⁻⁶/K |
| T_{g} | 623° C. |
| Density | 2.4 g/cm³. |

### Exemplary Embodiment 8

A further particularly preferred exemplary glass has the following composition, in wt %, prior to the chemical toughening:

| | |
|---|---|
| SiO₂ | 61.1 |
| Al₂O₃ | 19.6 |
| B₂O₃ | 4.5 |
| Na₂O | 12.1 |
| K₂O | 0.9 |
| MgO | 1.2 |
| CaO | 0.1 |
| SnO₂ | 0.2 |
| CeO₂ | 0.3. |

With this composition, the following properties of the substrate are obtained:

| | |
|---|---|
| α₍₂₀₋₃₀₀₎ | 8.9 · 10⁻⁶/K |
| T_{g} | 600° C. |
| Density | 2.4 g/cm³. |

### Exemplary Embodiment 9

A further particularly preferred exemplary glass has the following composition, in wt %, prior to the chemical toughening:

| | |
|---|---|
| SiO₂ | 60.7 |
| Al₂O₃ | 16.9 |
| Na₂O | 12.2 |
| K₂O | 4.1 |
| MgO | 3.9 |
| ZrO₂ | 1.5 |
| SnO₂ | 0.4 |
| CeO₂ | 0.3. |

In the context of the present invention, the transformation temperature T_{g} is defined by the point of intersection of the tangents to the two branches of the expansion curve when measuring with a heating rate of 5 K/min. This corresponds to a measurement according to ISO 7884-8 or DIN 52324, respectively.

Furthermore, unless otherwise stated, the linear coefficient of thermal expansion a is given for a range from 20 to 300° C. The notations α and α₍₂₀₋₃₀₀₎ are used synonymously in the context of the present invention. The given value is the nominal coefficient of mean linear thermal expansion according to ISO 7991, which is determined in static measurement.

### Exemplary Embodiment 10

Sheets of a glass having the composition according to exemplary embodiment 2 with a size of 140×140 mm² and a thickness of 70 μm were chemically toughened. Chemical toughening was performed in a KNO₃ bath at 430° C. for a duration of 4 hours.

Subsequently, the sheets were subjected to a temperature treatment as follows:

Heating was performed from room temperature to 500° C. at a heating rate of 10 K/min. The temperature was maintained at 500° C.

Subsequently, the samples were allowed to cool freely, i.e. cooling was effected by switching off the heater, with the furnace chamber open, according to the furnace characteristic.

A not chemically toughened sample of a glass with a composition according to exemplary embodiment 2 served as a reference.

After completion of the temperature treatment, the sheets were separated into samples of size 25×25 mm² using a CNC machine. The so obtained samples were characterized in terms of fracture probability according to a Weibull distribution.

It was found that the samples that were chemically toughened in advance were cut similarly to the samples that were not toughened in advance, without significant differences. Thus, the fracture probabilities are identical within the usual measurement accuracy.

### BRIEF DESCRIPTION OF THE DRAWINGS

Preferred embodiments of the invention will now again be explained with additional reference to drawings.

FIG. 1 schematically illustrates an electrical storage element;

FIG. 2 schematically illustrates a sheet-like glass; and

FIGS. 3 to 5 show fracture probabilities of different glasses in the form of a Weibull characteristic.

### DETAILED DESCRIPTION

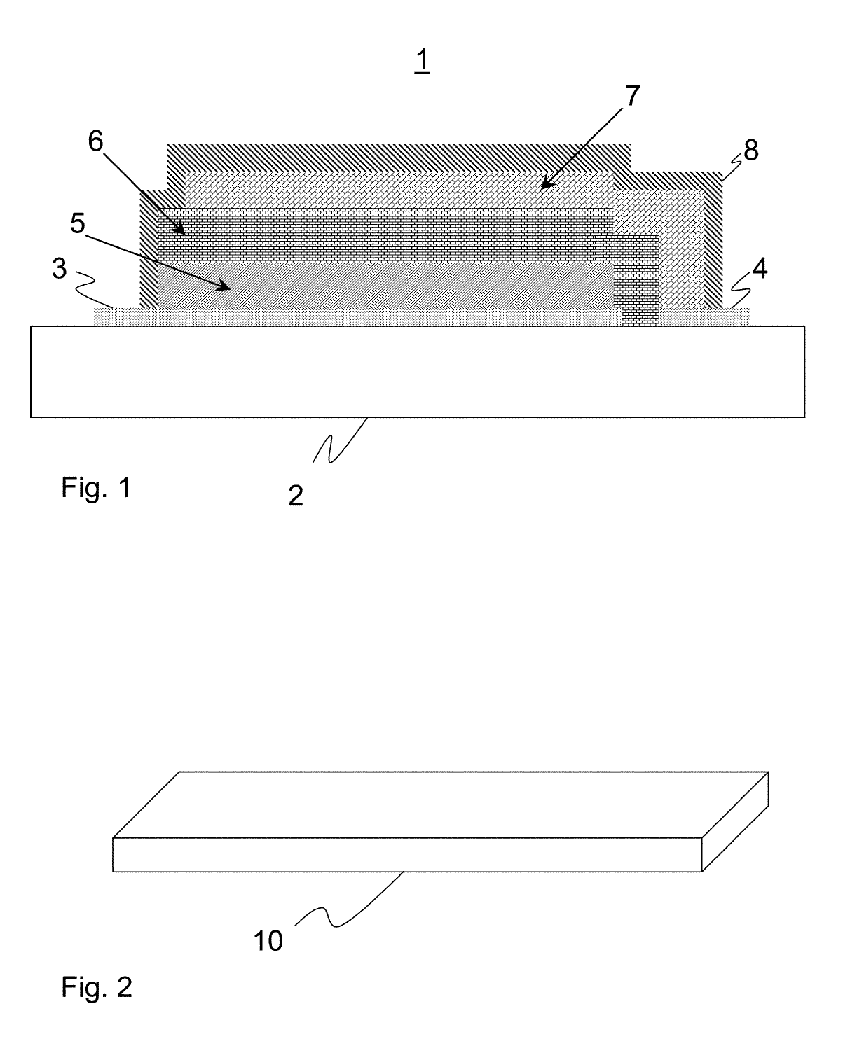

FIG. 1 schematically shows an electrical storage system 1 according to the present invention. It comprises a sheet-like glass 2 which is used as a substrate. A sequence of different layers is applied on the substrate. By way of example and without being limited to the present example, first the two collector layers are applied on the sheet-like glass 2, cathode collector layer 3, and anode collector layer 4. Such collector layers usually have a thickness of a few micrometers and are made of a metal, for example of copper, aluminum, or titanium. Superimposed on collector layer 3 is cathode layer 5. If the electrical storage system 1 is a lithium-based thin film battery, the cathode is made of a lithium/transition metal compound, preferably an oxide, for example of LiCoO₂, of LiMnO₂, or else of LiFePO₄. Furthermore, the electrolyte 6 is applied on the substrate and is at least partially overlapping cathode layer 5. In the case of a lithium-based thin film battery, this electrolyte is mostly LiPON, a compound of lithium with oxygen, phosphorus, and nitrogen. Furthermore, the electrical storage system 1 comprises an anode 7 which may for instance be made of lithium titanium oxide or else of metallic lithium. Anode layer 7 is at least partially overlapping electrolyte layer 6 and collector layer 4. Furthermore, the electrical storage system 1 comprises an encapsulation layer 8.

In the context of the present invention, any material which prevents or is capable of strongly reducing the attack of fluids or other corrosive materials on the electrical storage system 1 is considered as an encapsulation or sealing of the electrical storage system 1.

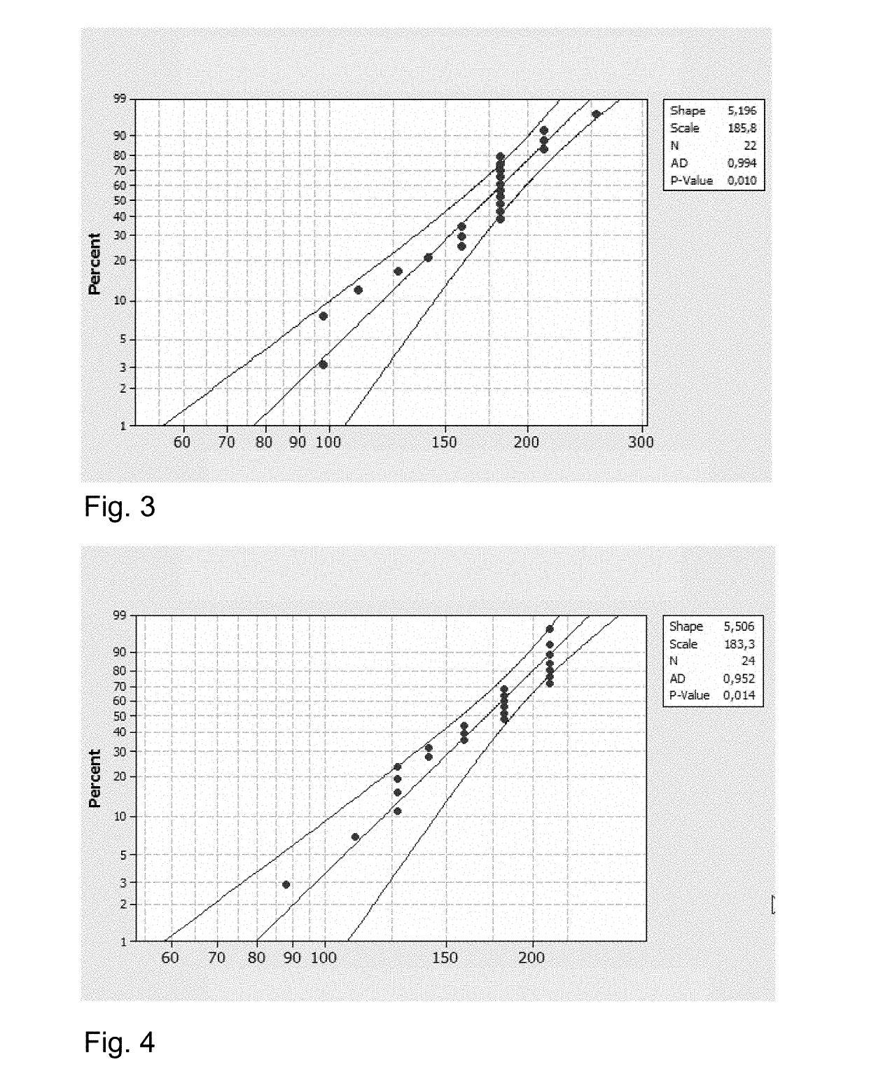

FIG. 2 schematically illustrates a sheet-like glass of a preferred embodiment according to the present invention, here in the form of a sheet-like shaped body 10. In the context of the present invention, a shaped body is referred to as being sheet-like or a sheet if its dimension in one spatial direction is not more than half of that in the two other spatial directions. A shaped body is referred to as a ribbon in the present invention if it has a length, width, and thickness for which the following relationship applies: the length is at least ten times larger than the width which in turn is at least twice as large as the thickness.

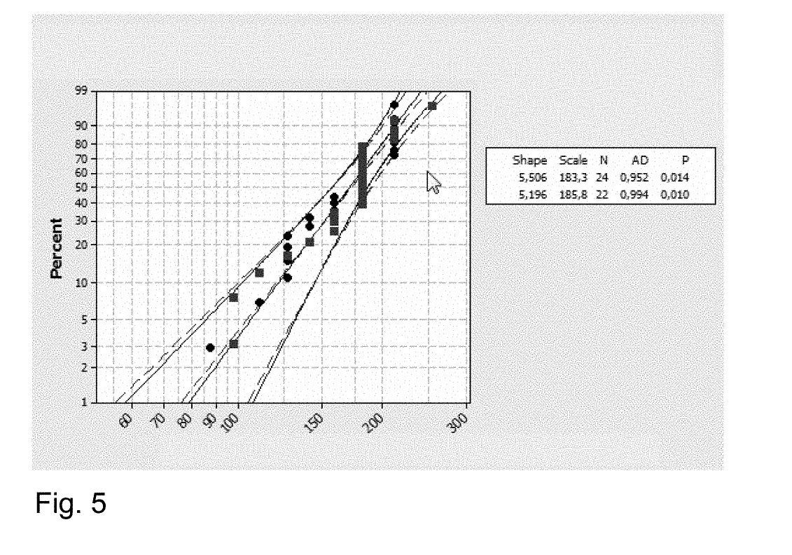

FIG. 3 shows the fracture probability for a totality of samples of sheet-like glasses with a composition corresponding to exemplary embodiment 2 and with a thickness of 70 μm with an temperature treatment according to exemplary embodiment 10. The samples examined here were not chemically toughened.

FIG. 4 shows the fracture probability for a totality of samples of sheet-like glasses with a composition corresponding to exemplary embodiment 2 with a thickness of 70 μm with an temperature treatment according to exemplary embodiment 10. The samples examined here had been chemically toughened (see exemplary embodiment 10).

In FIG. 5 the Weibull characteristics of FIGS. 3 and 4 are superimposed. The round symbols relate to the sheet-like glasses according to the invention, which were first chemically toughened and then subjected to a temperature treatment according to the exemplary embodiment 10 (see FIG. 4). The square symbols relate to the values obtained for non-toughened reference glasses (see FIG. 3). It is obvious that the Weibull distributions obtained for the respective totalities of samples are essentially identical, that is, they show no significant deviations. Thus, the cutting properties for the two sheet-like glasses are identical.

Thus, the method according to the invention significantly improves the handling of sheet-like glasses which are at least partially toughened, without causing an increase in the probability of fracture of the sheet-like glasses in the singularization process.

### LIST OF REFERENCE NUMERALS

1 Electrical storage system
2 Sheet-like glass used as a substrate
3 Cathode collector layer
4 Anode collector layer
5 Cathode
6 Electrolyte
7 Anode
8 Encapsulation layer
10 Sheet-like glass

What is claimed is:

1. A method for producing miniaturized electronic components, the method the steps of:
providing, as a substrate, a sheet-like glass toughened at least during a time period;
applying structures onto the substrate so that at least portions of the substrate carry the structures while other portions of the substrate remain free of the structures;
subjecting the substrate to a thermal load during at least one prior step; and
singularizing the substrate so that the portions of the substrate carrying the structures are obtained in singularized form.

2. The method as claimed in claim 1, wherein the at least one prior step comprises the step of applying the structures.

3. The method as claimed in claim 1, wherein the step of applying the structures comprises applying and patterning a sequence of layers, wherein the at least one prior step comprises the step of applying and patterning the sequence of layers.

4. The method as claimed in claim 1, further comprising applying a functional layer for the miniaturized electronic components to the substrate, wherein the at least one prior step comprises a thermal post treatment of the functional layer.

5. The method as claimed in claim 1, wherein the sheet-like toughened glass has a thickness of 300 μm or less.

6. The method for as claimed claim 1, wherein the step of providing the sheet-like glass comprises chemical toughening by an ion exchange in an exchange bath to provide a thickness of an ion exchange layer (L_{DoL}) of at least 10 μm and a compressive stress (σ_{CS}) at a glass surface of at most 300 MPa.

7. The method as claimed in claim 1, wherein the step of singularizing comprises a cutting process selected from the group consisting of mechanical cutting, thermal cutting, mechanical scoring, laser cutting, laser scoring, water jet cutting, hole drilling using an ultrasonic drill, sandblasting, and any combinations thereof.

8. The method as claimed in claim 1, the wherein the step of providing the sheet-like glass comprises providing a borosilicate glass sheet and/or an aluminosilicate glass sheet.

9. The method as claimed in claim 1, wherein the step of subjecting the substrate to the thermal load comprises subjecting the substrate to a heating method selected from the group consisting of resistance heating, electromagnetic radiation heating, induction heating, and any combinations thereof.

10. The method as claimed in claim 1, wherein the thermal load corresponds to a cumulative heat treatment between not less than 350° C. and not more than 600° C. during 1 to 15 hours.

11. A miniaturized electronic component comprising a sheet of glass having structures disposed thereon, the sheet glass being chemically toughened glass then subjected to a thermal load so that the sheet of glass has a thickness of an ion exchange layer of at least 10 μm and by a compressive stress at a glass surface of at most 300 MPa, wherein the thickness of the ion exchange layer prior to the thermal load is smaller than the thickness of the ion exchange layer after the thermal load, and wherein the compressive stress prior to the thermal load is greater than the compressive stress after the thermal load.

12. The miniaturized electronic component as claimed in claim 11, wherein the structures comprise a plurality of patterned layers.

13. The miniaturized electronic component as claimed in claim 11, wherein the thickness of the ion exchange layer is at least 25 μm.

14. The miniaturized electronic component as claimed in claim 11, wherein the compressive stress at the glass surface is less than 100 MPa.

15. The miniaturized electronic component as claimed in claim 11, wherein the sheet of glass has a thickness of 300 μm or less.

16. The miniaturized electronic component as claimed in claim 11, wherein the sheet of glass has a thickness of 50 μm or less.

17. The miniaturized electronic component as claimed in claim 11, wherein the sheet of glass comprises a borosilicate glass and/or an aluminosilicate glass.

18. The miniaturized electronic component as claimed in claim 11, wherein the sheet of glass is configured for use as a thin film battery.
